(19) United States
(12) Patent Application Publication
(10) Pub. No.: US 2017/0146766 A1
(43) Pub. Date: May 25, 2017

(54) IMAGING DEVICE AND METHOD OF ASSEMBLY

(71) Applicant: HON HAI PRECISION INDUSTRY CO., LTD., New Taipei (TW)

(72) Inventor: HSIN-YEN HSU, New Taipei (TW)

(21) Appl. No.: 15/050,630

(22) Filed: Feb. 23, 2016

(30) Foreign Application Priority Data
Nov. 25, 2015 (CN) 201510826222.3

(51) Int. Cl. G02B 7/02; H04N 5/225

(52) U.S. Cl. CPC G02B 7/025; G02B 7/023; H04N 5/2258; H04N 5/2253; H04N 5/2254

(57) ABSTRACT

The present disclosure relates to an imaging device. The imaging device includes a flexible printed circuit board, a first lens module, and a second lens module. The first lens module includes a first side. The second lens module includes a second side. The first side faces the second side, and defines glue receiving part. The first lens module and second the lens module are installed on the flexible printed circuit board side by side. The second side is adhered to the glue receiving part. The first lens module and the second lens module are adhered to each other through curing of curable adhesive in the glue receiving part.

### FIELD

The present disclosure relates to optical field, particularly to an imaging device and a method of assembling the imaging device.

### BACKGROUND

The multiple-camera modules improve virtual depth or resolution through analysis of a combination of images from multiple cameras.

### BRIEF DESCRIPTION OF THE DRAWINGS

Implementations of the present technology will now be described, by way of example only, with reference to the attached figures, wherein:

FIG. 1 is a flowchart showing a method for forming an imaging device of a first embodiment of the present disclosure.

FIG. 2 is a schematic view of a flexible printed circuit board of an imaging device, according to a first embodiment.

FIG. 3 is a schematic view of the flexible printed circuit board with an assembly of a first image sensor and a second image sensor.

FIG. 4is a schematic view of the image sensors assembled gaskets of FIG. 3.

FIG. 5 is a schematic view of the gaskets assembled lens module of FIG. 4.

FIG. 6 is a schematic view of the first image sensor and the second image sensor adhered to each other of FIG. 5.

FIG. 7 is a schematic view similar to the FIG. 6, removing one of the sensors.

FIG. 8 is a schematic view of a flexible printed circuit board of an imaging device, according to a second embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

One definition that applies throughout this disclosure will now be presented.

The term “comprising,” when utilized, means “including, but not necessarily limited to”; it specifically indicates open-ended inclusion or membership in the so-described combination, group, series and the like.

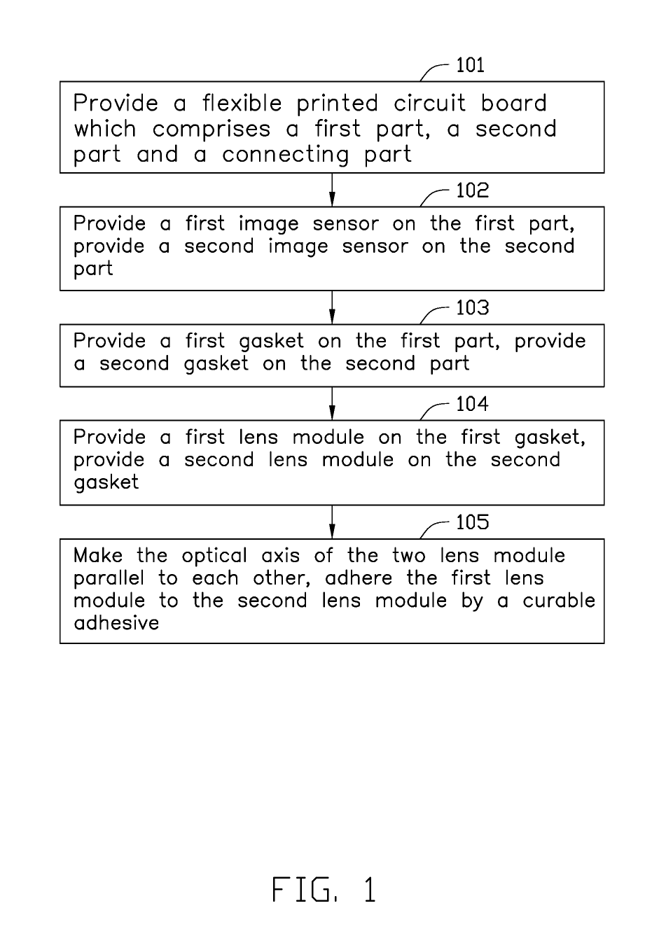

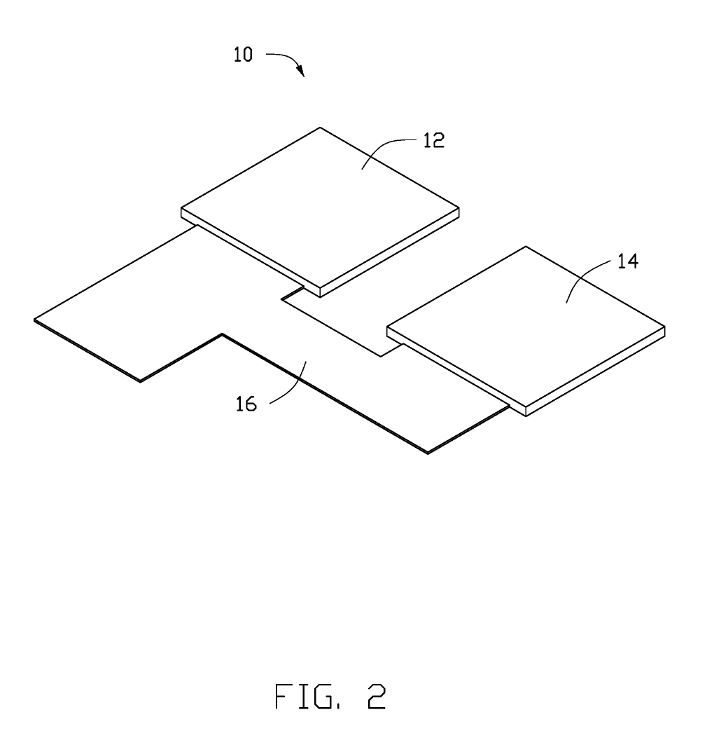

FIG. 1 is a flowchart presented in accordance with an example embodiment. The example method for making an imaging device is provided by way of example, as there are a variety of ways to carry out the method. The method described below can be carried out using the configurations illustrated in FIGS. 2 to 7, for example, and various elements of these figures are referenced in explaining example method. Each block shown in FIG. 1 represents one or more processes, methods or subroutines, carried out in the exemplary method. Additionally, the illustrated order of blocks is by example only and the order of the blocks can change according to the present disclosure. The exemplary method can begin at block 101.

At block 101, FIG. 2 illustrates a flexible printed circuit board 10 is provided.

The flexible printed circuit board 10 includes a first part 12, a second part 14, and a connecting part 16. The shape and size of the first part 12 is same as the second part 14. In the illustrated embodiment, both the first part 12 and second part 14 are cubes. The first part 12 is parallel to and spaced from the second part 14. The connecting part 16 is configured to connect the first part 12 and the second part 14, and connects the same side of the first part 12 and the second part 14.

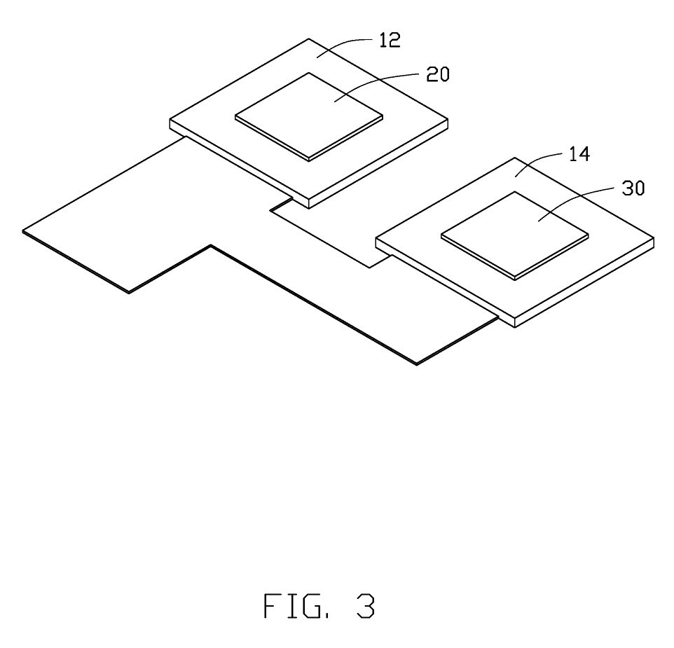

At block 102, FIG. 3 illustrates a first image sensor 20 and a second image sensor 30.

The first image sensor 20 is placed in the center of the first part 12. The second image sensor 30 is placed in the center of the second part 14. The shape and size of the second image sensor 30 is the same as the first image sensor 20.

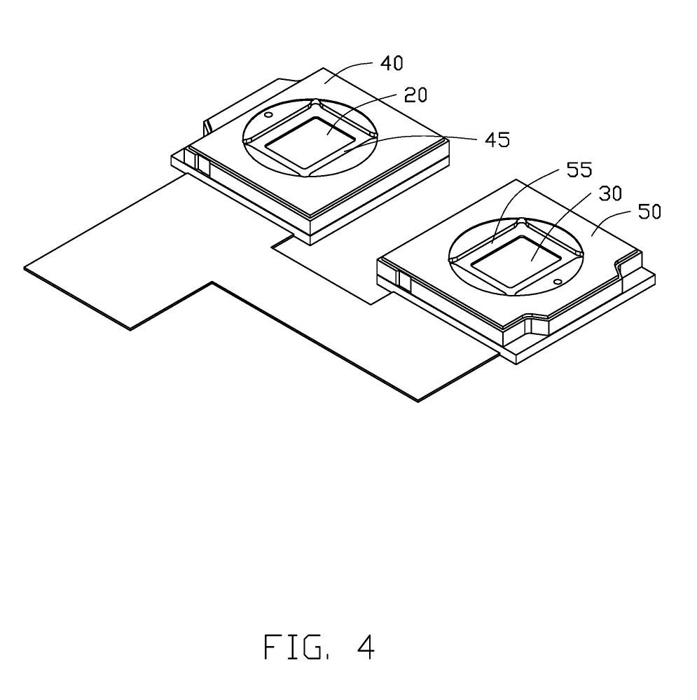

At block 103, FIG. 4 illustrates a first gasket 40 and a second gasket 50 is provided.

The first gasket 40 is positioned on the first part 12 covering the first image sensor 20. A first opening 45 is defined on the first gasket 40. The first opening 45 is defined at the center of the first gasket 40, and the first image sensor is exposed by the first opening 45.

The second gasket 50 is positioned on the second part 14 covering the second image sensor 30. A second opening 55 is defined on the second gasket 50. The second opening 55 is defined at the center of the second gasket 50, and the second image sensor 30 is exposed from the second opening 55.

The height of the first gasket 40 is the same as the second gasket 50. The first gasket 40 and the second gasket 50 have the same size and the same shape.

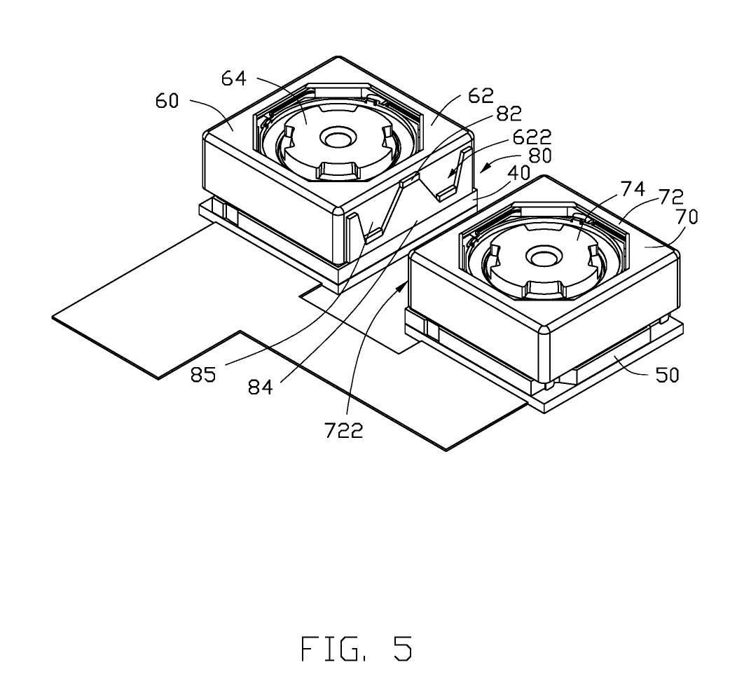

At block 104, FIG. 5 illustrates a first lens module 60 and a second lens module 70.

The first lens module 60 is set on the first gasket 40 covering the first image sensor 20. The second lens module 70 is set on the first gasket 50 covering the second image sensor 30.

The first lens module includes a first holder 62 and a first lens 64 received in the first holder 62.

The first holder 62 is a cube. The first holder 62 includes a first side 622 on the peripheral of first holder 62. A glue holder 80 is adhered on the first side 622. The glue holder 80 includes a first end 82 and a second end 84. The first end 82 is opposite to the second end 84. The first end 82 is close to the image side. The second end 84 is close to the object side. The glue receiving part 80 is composed of elastic material, such as foam.

A recess 85 is defined in the first end 82 extending towards the second end 85, but not running through the second end 84. The recess 85 can be any shape. In the illustrated embodiment, the recess 85 is a W-shape.

The second lens module 70 includes a second holder 72 and a second lens 74 which is received in the second holder 72.

The second holder 72 includes a second side 722 on the peripheral side of the second holder 72. The second side 722 faces the first side 622.

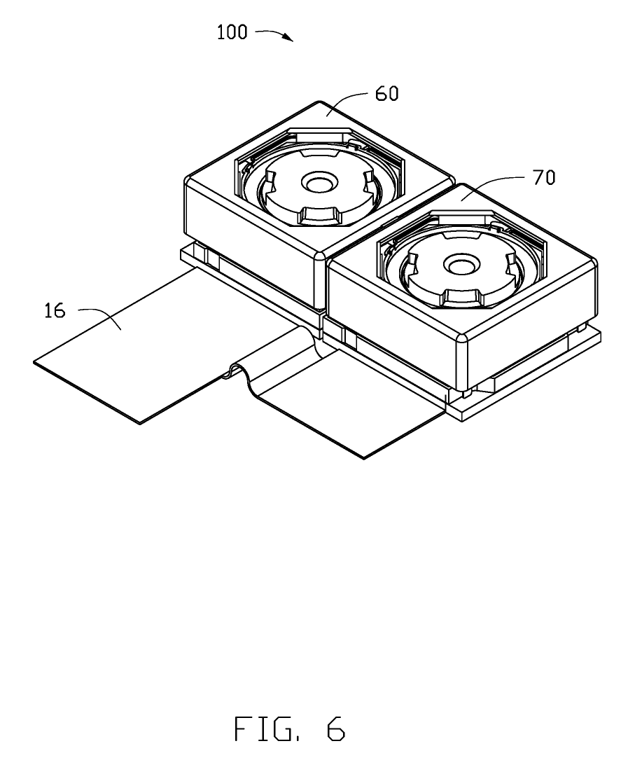

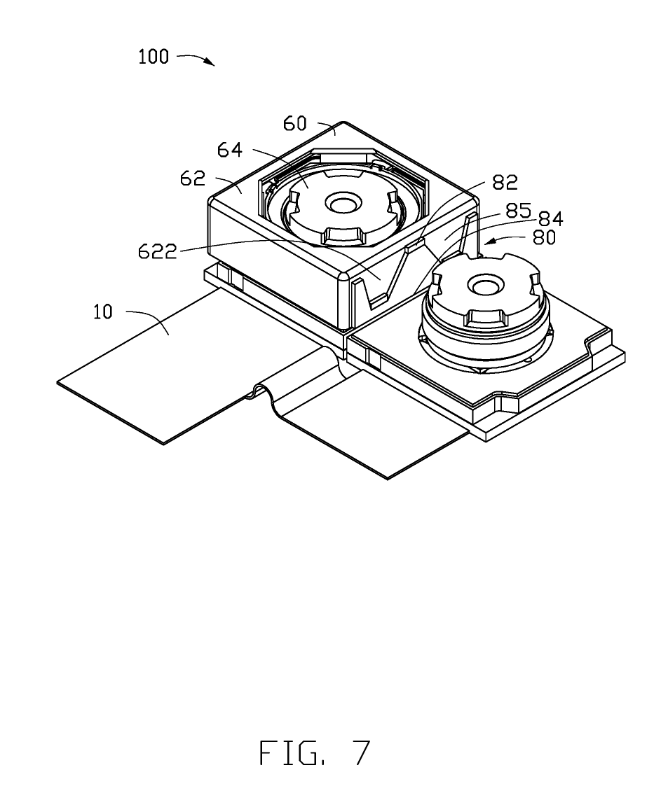

At block 105, FIGS. 6-7 illustrate when making sure the optical axis of the first lens module 60 and the second lens module 70 is parallel to each other, attitude of the second lens module 70 is adjusted. A curable adhesive is provided. The curable adhesive adheres the first lens module 60 to the second lens module 70.

Specifically, the second lens module 70 is moved to make the second side 722 move towards the first side 622 and eventually attach on the glue receiving part 80. At the same time, the center of junction 16 forms a half circle. The attitude of the second lens module 70 is adjusted to make the optical axis of the first lens module 60 and the second lens module 70 parallel to each other. The curable adhesive is injected into the glue receiving part 85, and the glue receiving part 85 is received in the recess 85, to make the first lens module 60 adhere to the second lens module 70. The curable adhesive inflows toward the second end 84 from the first end 82, and fills with the recess 85.

Understandably, the assembly of the imaging device 100 is completed after curing the curable adhesive. At the same time, the first lens module 60 is close to and side by side the second lens module 70. The height and orientation of the first lens module 60 is the same as the second lens module 70.

The present disclosure does not limit the assembly to two lens modules, and can also include assembly of multiple lens modules, all receivers are set in the peripheral of the lens module, the multiple lens modules are fixed together by curable adhesive.

FIGS. 6-7 illustrate an imaging device 100, according to a first embodiment.

The imaging device 100 includes a printed circuit board 10, a first lens module 60, and a second module 70.

The printed circuit board 10 includes a first part 12, a second part 14, and a connecting part 16. The first part 12 and the second part 14 are spaced. The connecting part 16 is connected to the same side of the first part 12 and the second part 14. The first lens module 60 is set on the first part 12. The second lens module 70 is set on the second part 14. The first lens module 60 includes a first side 622. The second lens module 70 includes the second side 722. The second side 722 faces the first side 622. The first side 622 defines a glue receiving part 80. The glue receiving part 80 is configured to receive glue. The glue receiving part 80 includes a first end 82 and a second end 84. The first end 82 is opposite to the second side 84. The first end 82 is close to the image side, the second end 84 is close to the object side. A recess 85 is defined on the first end 82. The recess 85 extends towards the second end 84, and it does not run through the second end 84. The recess 85 is configured with a coating of glue. The first lens module 60 and the second lens module 70 are installed on the flexible printed circuit board side by side, and the first lens module 60 is adhered to the second lens module 70 by curing.

The present disclosure illustrates that the first lens module 60 and the second lens module 70 are mounted on the flexible circuit board 10 side by side through setting a glue receiving part 80 which is configured to receive the glue on the flexible printed circuit board. The first lens module 60 is close to the second lens module 70, to achieve the alignment and fixation between the first lens module 60 and the second lens module 70. In the illustrated embodiment, no cover or frame is needed for relative positioning of the first lens module 60 and the second lens module 70, reducing the volume of the imaging device 100 for miniaturization support.

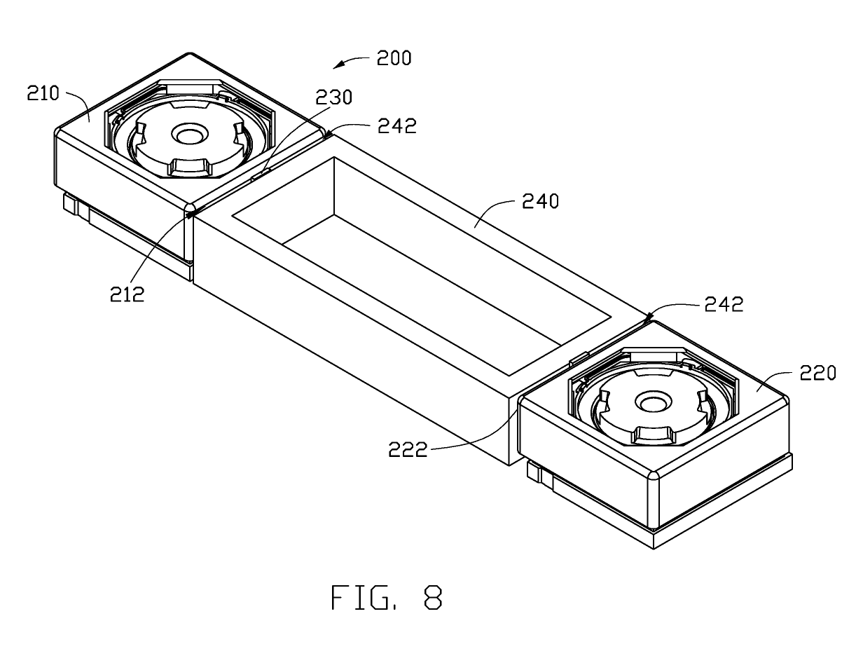

FIG. 8 illustrates an imaging device 200, according to the second embodiment. The imaging device 200 of the second embodiment is similar to the imaging device 100 of the first embodiment. The imaging device 200 includes a first lens module 210 and a second lens module 220. The difference between the two embodiments is that: in the illustrated embodiment, the first lens module 210 and the second lens module 220 are spaced, and they do not connect to each other directly. The imaging device 200 includes a bracket 240. Both the first side 212 of the first lens module 210 and the second side 222 of the second lens module 220 are attached with a glue receiving part 230. One side surface 242 is adhered on the first side 212 of the first lens module 210; the other side surface 242 is adhered on the second side 222 of the second lens module 220 via the glue receiving part 230.

The imaging device 200 of the illustrated embodiment has the same beneficial effect as the imaging device 100 of the first embodiment; therefore no repetition of the description is needed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An imaging device comprising:
a flexible printed circuit board;
a first lens module comprising a first side defining a glue receiving part for receiving glue; and
a second lens module comprising a second side adhered on the glue receiving part, the first side facing the second side;
wherein the first lens module and second the lens module are installed on the flexible printed circuit board side by side, and the first lens module and the second lens module are adhered to each other through curing of curable adhesive in the glue receiving part.

2. The imaging device of claim 1, wherein the glue receiving part comprises a first end and a second end, the first end is opposite to the second end, the first end is close to the image side of the first lens module, the second end is close to the object side of the first lens module, a recess is defined at the first end, the recess extends towards the second end, the recess does not run through the second end, the recess is configured to receive the curable adhesive.

3. The imaging device of claim 2, wherein the recess is presented with a W-shape.

4. An imaging device comprising:
a first lens module comprising a first side defining a glue receiving part for receiving glue;
a second lens module comprising a second side defining a glue receiving part for receiving glue; and
a bracket set between the first lens module and the second module comprising two side surface;
the first lens module spaced with the second lens module, the two side surfaces adhered on the glue receiving part, the first lens module, the second lens module, and the bracket adhered through curing of curable adhesive in the glue receiving part.

5. An assembly method of an imaging device, the method comprising:
providing a flexible printed circuit board, the flexible printed circuit board comprising a first part, a second part and a connecting part, the first part spaced with the second part, the connecting part connecting between the first part and the second part;
providing a first image sensor and a second image sensor, the first image sensor set on the first part, the second image sensor set on the second part;
providing a first lens module and a second lens module, both the first lens module and the second lens module comprising a holder and a lens which received in the holder, the first lens module set on the first image sensor and covering the first image sensor, the second lens module set on the second image sensor and covering the second image sensor, the first lens module comprising a first side, the second lens module comprising a second side, the first side set on the peripheral surface of the first lens module, the second side set on the peripheral surface of the second lens module, the first side and the second side facing towards each other;
attaching a glue receiving part on the first surface, the glue receiving part comprising the first end and second end, the second end opposite to the first end, the first end close to the image side of the first lens module, the second end close to the object side of the first lens module, the first end defining a recess, the recess extending towards the second end, and running through the second end;
bending the connecting part to make the second side attach on the glue receiving part; and
providing a curable adhesive, coating the curable adhesive on the recess to make the first lens module and the second lens module fixed.

6. The method of claim 5, wherein the curable adhesive flows into the second end from the first end, and fills the recess.

7. The method of claim 5, wherein the recess is presented with a W-shape.

8. The method of claim 5, wherein the glue receiving part is made of elastic materials.

9. The method of claim 8, wherein the elastic materials is sponge.

10. The method of claim 5, further comprising the following step before providing the curable adhesive to fix the first lens module and the second lens module: adjusting the attitude to make orientation of the lens of the first lens module and the second lens module same.
